(19) United States
(12) Patent Application Publication
(10) Pub. No.: US 2004/0204836 A1
(43) Pub. Date: Oct. 14, 2004

(54) System and method for using a map-based computer navigation system to perform geosearches

(76) Inventor: Terrance Patrick Riney, Seminole, FL (US)

Correspondence Address: Terrance P. Riney, 9209 Seminole Blvd #88, Seminole, FL, 33772, US

(21) Appl. No.: 10/751,124

(22) Filed: Jan. 3, 2004

Related U.S. Application Data
(60) Provisional application No. 60/437,975, filed on Jan. 3, 2003.

(51) Int. Cl. G01C 21/30

(52) U.S. Cl. 701/208; 340/995.1

(57) ABSTRACT

A navigational system for inter-connected networked computer system also known as the Internet. The navigational system uses an interface designed as automobile. It communicates with database to load multiple maps. Multiple maps are loaded allowing user to reference one of these maps threw the windshield of car graphic. User is then able to navigate through local county streets while system loads and loads separate maps that determine the extent of resolution from county level to perspective view of storefront. This allows for a streaming effect so user has no wait time while maps are refreshed. Database holds information displayed in maps such as number of street lanes, distance to well known points of interest. User can go to navigational device directly without need for text entry or enter it through well-known text box query.

### REFERENCE

Reference: Non-Provisional Patent No. 60/437,975

### FIELD OF THE INVENTION

This invention relates to map-based navigation systems. More specifically, it relates to a system and method for using a map-based computer navigation system to perform geosearches.

### BACKGROUND OF THE INVENTION

Current map-based computer navigation systems based on either Geographical Information System (GIS) technology or Global Positioning System (GPS) technology or a hybrid of both are well known in the prior art. These current map systems rely on a variety of text-based and/or graphic interfaces to present information from the underlying GIS/GPS technology to the end user. One common feature of the existing systems is that they typically present information to a user as static graphic with accompanying text. In other words, they do not allow the user to ‘virtually’ drive prospective routes. This is desirable because it will enable users to dynamically find an imperfectly remembered location or verify the suitability of the proposed trip routing. Users' ‘drive’ will more closely approximate their real life transportation experience this would reduce user' expenditure of time and energy and consequently allows users to get information on more points of interest for a given level of effort. In above-mentioned systems, GPS or GIS no real option is available for specific and detailed information as in ‘this east entrance to Interstate is located on north side of road and subsequent west entrance is located on south side’, or ‘this exit has is divided into east and west’.

A system that dynamically accesses desired information would reduce user' expenditure of time and energy and consequently allows users to get information on more points of interest for a given level of effort. A natural consequence of systems that rely on static information is a lack of additional information on specific businesses that are retrieved without further text input. Such input breaks the normal flow a user would get from a ‘drive’. Moreover, a system that minimized keyboard input requirements would help reduce the possibility of repetitive motion injuries such as carpal tunnel syndrome.

In prior map-based navigation systems, the end user typically enters text in an input form's predefined fields to access data from the underlying GIS/GPS technology. An example of this is the driving directions feature found on several Internet sites. A user enters the desired starting and stopping points and the navigation system generates a suggested route including both a map and an accompanying text description. The user can then use various interface buttons to modify the resulting map. For example the user can enlarge (zoom in) or reduce (zoom out) the map scale. However, the resulting map still presents information to the end user as a static graphic with accompanying text. Numerous variations on map-based computer navigation systems are show in the prior art. Various trip routing systems allow a user to add items/points of interest to trip routing maps. For example, U.S. Pat. No. 6,282,489, issued to Bellesfield, et. al. on Aug. 28, 2001, discloses methods, and an apparatus for displaying a travel route and generating a list of places of interest located near the travel route. After a user selects a departure point and a destination point, the routing components employs the routing database to generate and display a route between the selected departure and destination points. If the user requests a list of places near the displayed route, the place selection component employs the places of interest database to generate and display a list of places of interest which are within a predetermined distance of the generated route. U.S. Pat. No. 5,948,040, issued to Delorme, et. al. on Sep. 7, 1999, discloses computerized travel reservation information and planning system that, among other features, enables users to pick types of attractions or accommodations within a user-selected region around routes of travel. Similarly, the prior art includes systems that annotate landmarks as navigational aids on a routing map. U.S. Pat. No. 6,477,460, issued to Kepler on Nov. 5, 2002, discloses a process and system for the annotation of machine-generated directions with easily recognized landmarks and other relevant information. U.S. Pat. No. 6,405,129, issued to Yokota on Jun. 11, 2002, discloses a method of displaying point of interest icons on the display of a navigational system that presents an icon or icons belonging to an icon type which appear on a map in a smaller number from disappearing behind icons belonging to another icon type which appear on the map in a larger number. These systems include point of interest and landmark annotation on routing maps but do not enable a user to find a specific point of interest whose particular details are not previously known to the user.

Other map-based computer navigation systems allow a user to generate maps of the items or points of interest in a specific area. For example, U.S. Pat. No. 6,415,291, issued to Bouse, et al. on Jul. 2, 2002, and U.S. Pat. No. 6,408,307, issued to Semple, et al. on Jun. 18, 2002, respectively disclose a system and related methods for remotely accessing a selected group of items of interest from a database. These inventions enable a user to access a common database from a remote communications port to generate a map that locates selected items of interest, e.g., a display of sporting shops in the vicinity of Chicago O'Hara International Airport. U.S. Pat. No. 6,240,360, issued to Phelan on May 29, 2001, also discloses a computer system for identifying local resources based superimposing information relating to a place of interest on a geographic map. Similarly, U.S. Pat. No. 6,397,143, issued to Peschke on May 28, 2002, discloses a map navigation and display system based on the visual presentation of a shopping center showing the layout of the buildings and stores within the center. Each store is then linked to its own page with details about the business. Higher level maps may also show the layout and location of the shopping centers within a neighborhood or district and within a region. Optional density indicators at the regional level assist users in location areas with a large number of stores. Although these inventions focus on mapping points of interests rather than simply annotating points of interests on a routing map, they still result in static maps with the resulting limitations as discussed above. These inventions do not enable ease of movement between points of interest and in some instances fail to disclose a means by which to place points of interest on maps. Moreover, they impose time delays as maps are redrawn in response to each user input.

Other systems incorporate a moving map display that tracks vehicle progress down a Mar. 5, 2002, discloses an in-vehicle computer architecture that executes a vehicle-environment modeling program based on inputs from environmental sensors, hardware sensors, and a map database. U.S. Pat. No. 6,035,253, issued to Hayashi, et al. on Mar. 7, 2000, a navigation apparatus for a vehicle that plots the present position of the vehicle on a map centered on the present vehicle location. U.S. Pat. No. 6,445,397 issued to Boyer on Sep. 3, 2002, discloses an apparatus for guiding a vehicle improved map scale control. Although these inventions incorporate dynamic displays, they do not enable a user to ‘virtually’ drive prospective routes. They are in effect limited to the area in the immediate vicinity of the vehicle.

It is an object of the present invention to enable users to ‘virtually’ drive prospective routes because this will enable them to dynamically find the location of an imperfectly remembered establishment or to verify the suitability of the proposed routing. It is another object of the present invention to enable users to easily find points of interest and events of interest.

It is another object of the present invention to provide users with realistic view of the geographical information using dynamic graphics to represent three-dimensional structures.

It is another object of the present invention to provide an intuitive, user-friendly interface that minimizes text based input requirements.

It is another object of the present invention to organize access to World Wide Web information on public and commercial buildings by their true life geographic location.

### SUMMARY OF THE INVENTION

The current invention provides a system and method of using a map-based computer navigation system to perform geosearches. It provides access to information in a geopraphic database through an interface designed to simulate the view through a car's front windshield. The use of dynamic graphics (‘movie’) to represent landmarks and buildings that would b seen while traveling along a user determined route enables users to ‘virtually drive’ prospective routes and thus find the location of an imperfectly remembered establishment or verify the suitability of the proposed routing.

In the preferred embodiment, the interface control are modeled on an automobile steering wheel and stick shift to enable intuitive user-friendly use. The user controls the direction of a search using the ‘steering wheel’ and the scale at which information is presented using the ‘stick shift’. An instrument panel on the dashboard allows the user to see total miles progressed as well as being able to view the length of various sub-routes.

By dynamically accessing desired information,. The present invention will reduce user' expenditure of time and energy and consequently allow users to get information on more points of interest for a given level of effort. Moreover, by minimizing keyboard input requirements, the present invention will help reduce the possibility of repetitive motion injuries such as carpal tunnel syndrome.

### BRIEF DESCRIPTION OF THE DRAWINGS

Other features and advantages of the present invention will become apparent in the following detailed description of the preferred embodiment with reference to the accompanying drawings, of which:

FIG. 1 Label of ‘Local Search’ with text box for entry of text search

FIG. 2 Graphic of States and individual counties with navigational device that shows steering device with ‘stick shift’ in ‘fifth gear’ to change gears and allow further depth

FIG. 3 Graphic of specific county with steering wheel and stick shifter in 4^{th} gear

FIG. 4 Graphic of specific city with steering wheel and stick shifter in 3rd gear

FIG. 5 Graphic of specific county with steering wheel and stick shifter in 2nd gear

FIG. 6 Graphic of virtual tour with text stating “paused” indicating user has pressed spacebar to halt virtual tour for more information with steering wheel and stick shifter in 1st gear

FIG. 7 Block Diagram showing flow of files loading and unloading.

### DETAILED DESCRIPTION OF THE INVENTION

As discussed above, the present invention, disclosed herein, is a system and method for using a map-based computer navigation system to perform geosearches. The current embodiment is described below as an example but those skilled in the are will recognize modifications can be made without departing from the present invention.

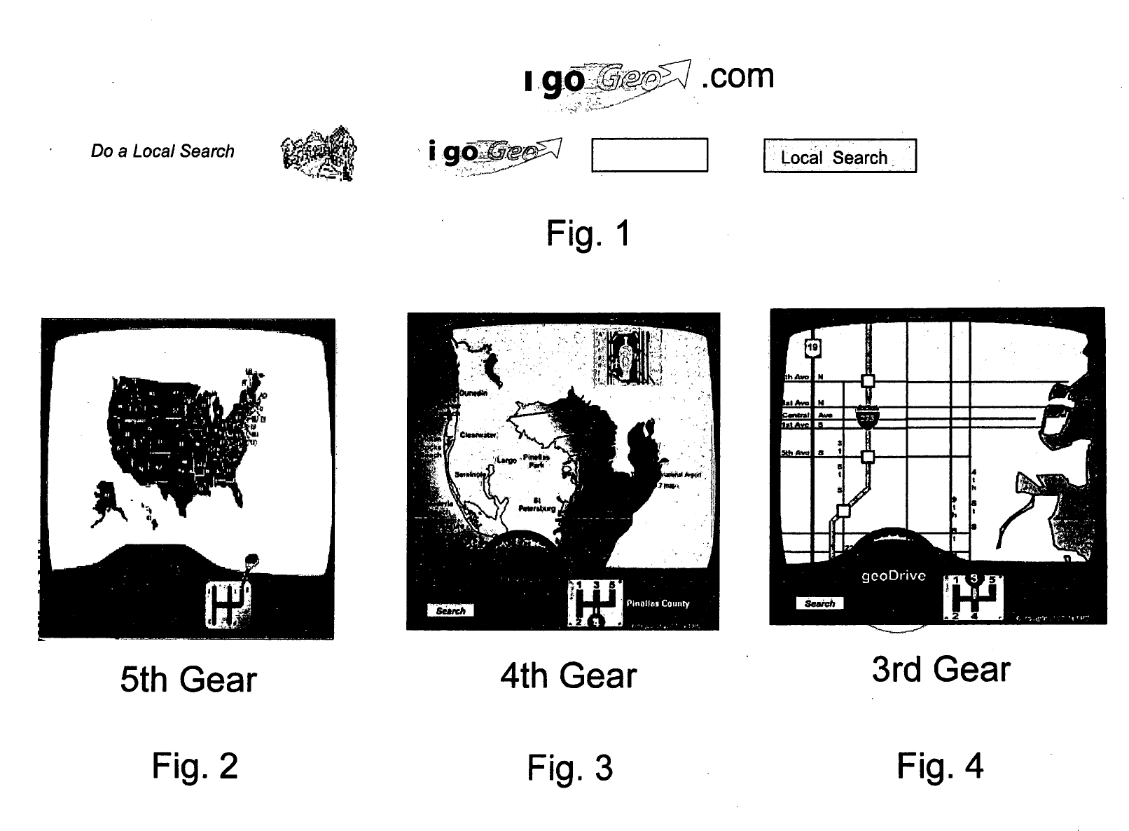

In the preferred embodiment, the system has two entry points, a user can use a text box to perform a customary search of database. FIG. 1 shows an area where user will enter desired text and this position has label along side it stating ‘Local Search”. The results of this type of search will come in the customary form of text indicating a hyperlink. The hyperlink could be that of a store or a government office or local school. Clicking on a specific link this way will prompt the navigational devise to load in second gear where store, government office or local school is located. The result is a map of the overhead or birds eye view of intersection or business area of desired entity. This map shown through the windshield of navigational device will indicate the address and an outline of desired entity but also any thoroughfares that are adjacent and the number of street lanes in front of entity. The navigational device is equipped with a steering wheel and stick shift as shown in FIG. 2. The user is able to use the steering wheel to drive around area of initial interest to obtain further information. The database will recognize the present position of gear and map of entity and any further text searches at this point will only include that part of the database that is local in relation to initial entity. A more global search can be obtained by moving back to fifth gear and repeating above instructions.

A second way of doing a search is to begin driving as shown in FIG. 2 where individual states can be brought up by using steering wheel to scroll them through the windshield. The graphic of each state is further divided into graphics that represent their. counties. Each state scrolls by one at a time until user has selected desired state. By using the steering wheel the user can control a graphic of an automobile superimposed on the state graphics to indicate the county of choice. When desired county is found the user would shift the stick shift to fourth gear. Alternatively user can click on text of county and stick shift will automatically shift to fourth gear.

At the county level, FIG. 3, individual cities will be placed according to their longitude and latitude. A text label will indicate their position and user can click on this label and navigational device will shift to 3^{rd} gear shown in FIG. 4. Alternatively user can click on gear plate which is labeled according to specific gear, by clicking on the number 3 the gear shifter will move to that position showing the surrounding city. User can also click and hold on shiftier and slide in the same way one would shift an automobile' gears to its desired position.

In third gear any interstate that may be present will be label as such and have squares used as labels to indicate entrances or exits from highway. By clicking on one of these squares the shifter will automatically move to 1^{st} gear, FIG. 6, and user will see a three dimensional movie of that particular entrance or exit and the exact number of lanes at that point. By doing this user who is headed on vacation can stay in first gear and travel their desired trip while seeing exact replica of interstate and all businesses along the side of the interstate. At each exit user can turn steering wheel to leave interstate and continue down road to city of choice.

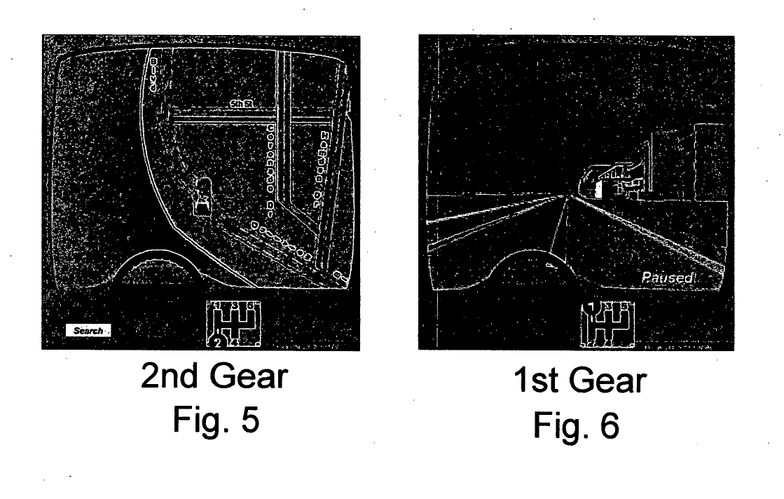

Once user has located the general area of interest in third gear they will change gears to second and see an overview of business district or campus of interest, FIG. 5. At any point other than first gear a ‘search’ box will be present on the dashboard of the navigational devise. This allows the user to do a text search of specific entity desired. By clicking on this search box text categories will replace maps in the navigational devices windshield. As user clicks on category of interest, sub categories may appear. Once user has found the place of business they desire they will click on that text which will load a map of second gear showing address and business name and any through fares in adjacent area.

By shifting into different gears, the user can access the neighborhood county, state or national road networks and continue to control the direction of progress using the steering wheel. A car icon superimposed on a road network will allow the user to direct the progress of the car icon using the steering wheel. As the car progresses in the higher gears, information about landmarks, exits, and nearby stores is presented in a scrolling fashion in a secondary window.

For example, this invention could enable a user in Tampa to retrieve information on a store previously visited in Orlando even if the user did not remember the stores name or exact location. On initial system startup, the view from the users dashboard would reflect a local Tampa street. The user would shift into fourth gear and use the steering wheel to guide the resulting car icon along the state highway network to Orlando. The user would then downshift into second gear and use the steering wheel to guide the car icon along the county road network to the general neighborhood of the store. The user would then downshift to first gear and virtually drive around the neighborhood to find the store. The user would then steer to the store and beeping the horn to access additional information about the store. User is able to press on spacebar of keyboard in order to ‘pause’ virtual tour.

The graphics representing signs and buildings along the street scroll past as the user progresses down the street. Labels for residential buildings can include their addresses. Labels for commercial and public buildings would also include their names and other identifying information. Various visual schemees such as icons or color-coding can be implemented to facilitate identification of the type of building. As the ‘movie’ progresses down the street, the user can select a particular storefront or steer down another street at an intersection using the ‘steering wheel’. Each business would have storefront represented in first gear, user would be able to utilize pointing devise to enter store. The user would then see the entire interior of business and be able to move pointing device to elevator or marquise of business directory. In the preferred embodiment, the user controls the direction of progress by moving the ‘steering wheel’ FIG. 2 using a computer mouse. However, but those skilled in the art will recognize that other cursor control devices and even other means controlling the direction of progress such as using arrow devices and even other means controlling the direction of progress such as using arrow keys on a computer keyboard can be implemented without departing form the present invention. By minizing keyboard input requirements, the present invention will help reduce the possibility of repetitive motion injuries such as carpal tunnel syndrome and will reduce user' expenditure of time and energy in accessing desired information.

By dynamically accessing desired information, the present invention will reduce users expenditure of time and energy and consequently allows users to get information on more points of interest for a given level of effort. Moreover, by minimizing keyboard input requirements, the present invention will help reduce the possibility of repetitive motion injuries such as carpal tunnel syndrome.

As a user progresses through a given movie, movies that are likely to be accessed next are preloading. These include the movie for the next stretch of street along which the user is progressing as well as movies for approaching cross-streets and higher-level graphics that will be accessed if the user shifts gears. The once a political boundary has been passed system would load new political boundaries when is shifted to higher gear. This will further reduce the time required to access desired information. For a user looking for an imperfectly remembered address or various points of interest, these reductions in access time are cumulative.

After selecting an individual commercial or public building, the user will beep the horn to access additional information about the building occupants. The extent of this additional information will vary but may include items such as contract information, panoramic 360-degree views of individual businesses, a building director, and links to the websites of business in the building,. Business will be able to devop their own business front on-line. In the preferred embodiment, the dashboard graphic shown in FIG. 1 dissolves into a graphic of the building lobby with a building directory an an elevator access button after the user beeps the car horn 3. The elevator is used to access other floors. Once inside the elevator, the user will select the desired floor from options shown on the wall of the elevator. Those skilled in the art will recognize that other approaches such as links directly from the building directory can be used without departing grom the present invention.

In another example, a real estate agent could take prospective buyers on a virtual drive around prospective neighborhoods to see how far away police stations, fire stations, schools, grocer markes, and play grounds are from a listed house. This would be particularly useful for those buyers who have limited time to visit prospective homes and those looking form other states.

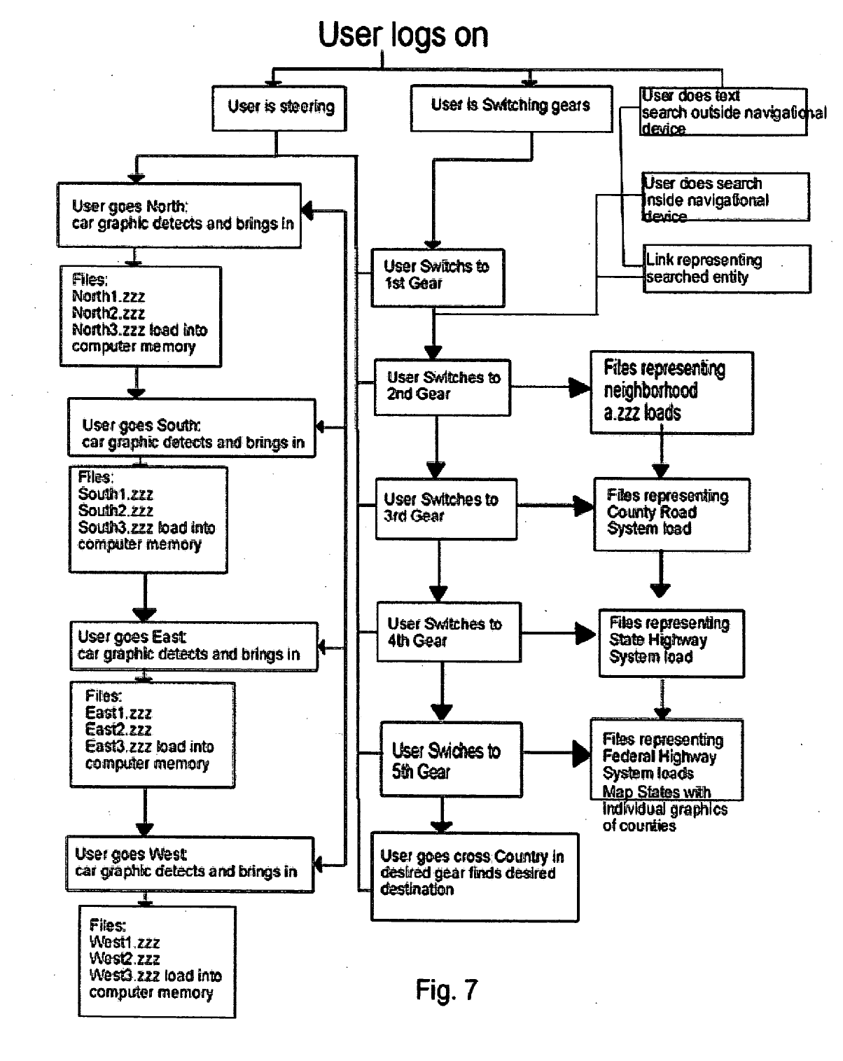

FIG. 7 presents schematic of the systems methods of operation. Movies of individual streets are arranged st that reaching the end of one movie as the user progresses along a street or turns off onto a new street automatically selects and starts the appropriate next movie. Similarly, the system detects the location of the car icon when shifting gears and automatically selects and starts the appropriate next movie. In the preferred embodiment, the system stores movies according to longitude or latitude/plats for easy reference and access. The interface accesses information in an associated database that includes information on pints of interest stored in a hierarchical organizational system.

I claim:

1. A geographic information system comprising:
a set of inter connected computers commonly known as the Internet
a computer server with connection to said Internet
a database that resides on said server, software program to interface with said database and programmable array
a software program to interface with said array enabling a sequence of maps to be loaded and unloaded
a navigational device to interact between said array and user in order to display said maps and choose direction and level

2. A geographic information system as set forth in claim 1 further comprising:
said navigational device retrieved from said server which once loaded on users computer stays loaded
said navigational device appears as dashboard of typical automobile with windshield used as focus and reference point

3. A navigational device as set forth in claim 3 and further comprising two subsystems of said dashboard:
(a) a device commonly known as a ‘steering wheel’ such that once clicked and dragged by pointing device will rotate 360 degrees and interfaces with said array
(b) a device commonly known as a ‘stick shift’ which when clicked and dragged
(c) to designated spots moves user up a level or down a level and interfaces with said array

4. A navigational device as set forth in claim 3 such that when said steering device rotates arc is broken into four segments which when user turns into a portion of said segment a direction is stipulated and said program interacts with said array loading a map corresponding to that direction

5. A navigational device such that when user enters said gear nine individual maps are loaded in Random Access Memory

6. A navigational device as set forth in claim 5 where only map in center of nine maps is visible and is located in said windshield and movement in north, south, east or west will load 3 maps and unload 3 maps

7. A navigational device as set forth in claim 6 where with reference to visible map new map loaded will be the next sequential map in desired direction and two maps adjacent to said map, a similar set of maps in opposite direction will unload

8. A navigational device as set forth in claim 3 such that said stick shift will have a hot spot on its knob such that a user will click and drag to a desired location

9. A navigational device as set forth in claim 8 such that said stick shift will be located on gear plate on said dashboard

10. A navigational device as set forth in claim 9 such that numbers one, three and five are located on the top of said gear plate and numbers two and four are located on bottom of said clutch plate and moving said stick shift toward a number on said clutch plate will load nine maps corresponding to that level

11. A navigational device as set forth in claim 10 such that within each level maps are loaded which correspond geographically to where user was in higher or lower level when they changed gears

12. A navigational device as set forth in claim 11 such that:
fifth gear represents a country with individual states
fourth gear is state with individual counties
third gear represents an area of the county
second gear represents an overview of a business district intersection
first gear represents a virtual drive through business district

13. A navigational device as set forth in claim 12 such that:
when moving into higher levels array loads maps representing political boundaries from geographic area represented by lower level

14. Second gear maps as set forth in claim 12 and further comprising:
the exact number of lanes on a specific stretch of highway
the exact location of entrance to highway
the exact location of entrance signs to highway
the exit number of desired exit
the approximate angle of curve of exit
the placement of any signal lights or stop signs on exit

15. First gear maps as set forth in claim 12 and further comprising:
a three dimensional drive where user can use computer keyboard to pause and enter desired business
the user can use pointing device to move into building once inside building user will be able to search building marquise in order to find specific floor or office
the user will be able to use pointing device to enter elevator clicking on elevator wall for desired floor or office said business will have link to their Internet site Internet sites are arranged geographically

16. Each distinct map represents a specific longitude and latitude as set forth in claim 14 and further comprising:
said map will have permanent information such as landmarks, bridges, interstates
said map will have symbols superimposed over said permanent information to represent real time events such as traffic accident, construction site other mishaps

17. A navigational device as set forth in claim 3 and said dashboard:
provides text area representing street names as maps progress through county or city
provides ability to instruct through text mileage between points of interest provides ability to show speed measured in pixel per nanosecond

18. A system commonly known as a search engine where a text box for user interaction with database and where information on individual businesses are queried and results are in the form of known text links and further that clicking on desired link will load said navigational device

19. A system as set fourth in claim 16 and further comprising:
That clicking on said link will load said navigational device and map representing geographic area of desired business said map will contain symbol of desired business and nine individual maps representing said second gear of geographic area surrounding desired business

20. A system as set forth in claim 16 and further comprising:
A means for users to register from said Internet
A means for business to input their information into said database
